(19) United States
(12) Patent Application Publication
(10) Pub. No.: US 2004/0252944 A1
(43) Pub. Date: Dec. 16, 2004

(54) Apparatus and method of manufacturing optical waveguide type diffraction grating device

(75) Inventors: Ken Hashimoto, Yokohama-shi (JP); Kiyotaka Murashima, Yokohama-shi (JP); Toshikazu Shibata, Osaka (JP); Akira Inoue, Yokohama-shi (JP)

Correspondence Address: MCDERMOTT WILL & EMERY LLP, 600 13TH STREET, N.W., WASHINGTON, DC, 20005-3096, US

(73) Assignee: Sumitomo Electric Industries, Ltd.

(21) Appl. No.: 10/864,523

(22) Filed: Jun. 10, 2004

(30) Foreign Application Priority Data
Jun. 10, 2003 (JP) P2003-165376

(51) Int. Cl. G02B 6/34

(52) U.S. Cl. 385/37

(57) ABSTRACT

The present invention relates to a method and apparatus which make it possible to manufacture an optical waveguide type diffraction grating device achieving desired optical characteristics easily. In the present method, the optical fiber is irradiated as refractive index change inducing light outputted from a light source through a phase grating mask after passing through a shutter, an optical system, and a mirror. The mirror is moved in the direction of a z-axis to scan the irradiating position of the refractive index change inducing light on the optical fiber plural times. Every scan among the plurality of scans of the irradiating position, the phase grating mask is relatively displaced along the z-axis the direction opposite to each other from a reference relative position of the phase grating mask relative to the optical fiber.

### BACKGROUND OF THE INVENTION

1. Field of the Invention

The present invention relates to an apparatus and a method of manufacturing an optical waveguide type diffraction grating device in which a diffraction grating as refractive index modulation is formed over a predetermined range of an optical waveguide in a longitudinal direction thereof.

2. Related Background Art

An optical waveguide type diffraction grating device comprises a diffraction grating as refractive index modulation formed over a predetermined range in the longitudinal direction of an optical waveguide (e.g., an optical fiber), and it is capable of selectively reflecting light component having a predetermined reflection wavelength among light components guided through the optical waveguide. A multiplexing/demultiplexing module including such an optical waveguide type diffraction grating device is capable of multiplexing or demultiplexing light components by selectively reflecting light component having the reflection wavelength utilizing the optical waveguide type diffraction grating device. It is used in a wavelength division multiplexing (WDM) transmission system for performing optical transmission utilizing multiplexed signal light, which has been wavelength-multiplexed.

In general, in an optical waveguide type diffraction grating device, a diffraction grating as refractive index modulation at a constant period λ is formed over a predetermined range in the longitudinal direction of an optical waveguide. The diffraction grating diffracts light component having a Bragg reflection wavelength λ that satisfies a Bragg conditional expression “λ=2nₒλ” and transmits light components having other wavelengths. What is represented by nₒ is an average effective refractive index in a refractive index modulating region of the optical waveguide.

In such an optical waveguide type diffraction grating device, the distribution of amplitudes of refractive index modulation in the longitudinal direction of the refractive index modulating region may be uniform or non-uniform. By varying the distribution of the amplitudes of refractive index modulation in the longitudinal direction, the optical waveguide type diffraction grating device is intended to achieve improved optical characteristics. The optical characteristics of the optical waveguide type diffraction grating device are intended to be further improved when the distribution of amplitudes of refractive index modulation includes a phase-inverted portion.

An apparatus and a method of manufacturing such an optical waveguide type diffraction grating device are disclosed in Document 1. In the apparatus and method disclosed in Document 1 (Japanese Patent Laid-Open No. JP-A-2003-29061), an optical waveguide type diffraction grating device is manufactured by vibrating a phase grating mask provided beside an optical waveguide relative to the optical waveguide in the longitudinal direction thereof and irradiating the optical waveguide with refractive index changes inducing light through the vibrated phase grating mask while scanning the light in the longitudinal direction to form a diffraction grating as refractive index modulation in the optical waveguide.

### SUMMARY OF THE INVENTION

The inventors have studied conventional optical waveguide type diffraction grating device in detail, and as a result, have found problems as follows.

Namely, the optical characteristics pertaining to the conventional optical waveguide type diffraction grating device manufactured by the apparatus and method disclosed in Document 1 correspond to the waveform of the relative vibration of the phase grating mask in each irradiating position in the longitudinal direction thereof during a scan. The optical characteristics of the optical waveguide type diffraction grating device thus manufactured depend on the amplitude of refractive index modulation in each position in the longitudinal direction thereof as well as the distribution of amplitudes of refractive index modulation in the longitudinal direction.

Therefore, in order to manufacture the optical waveguide type diffraction grating device with optical characteristics accurately as designed, the relative vibration of the phase grating mask in each irradiating position in the longitudinal direction during a scan is required to be the one as designed; the refractive index change inducing light is required to be scanned through the irradiating positions at a high speed; and the relative vibration of the phase grating mask is required to have a high frequency.

However, it is difficult to cause the relative vibration of the phase grating mask as designed when the refractive index change inducing light is scanned through the irradiating positions at a high speed and the relative vibration of the phase grating mask has a high frequency. For example, when it is attempted to vibrate the phase grating mask in the form of a rectangular wave, the movement of the phase grating mask from one displaced position to another displaced position during the vibration requires a certain transition time in practice, although it is idealistic that the movement occurs instantaneously. The transition time causes the waveform of the vibration of the phase grating mask different from the one to be intended. When the irradiated positions are scanned at a high speed or when the vibration frequency is high, the influence of the transition time on the irradiation with refractive index change inducing light becomes too significant to ignore, and there will be great differences between the optical characteristics of an optical waveguide type diffraction grating device thus manufactured and designed values of the same.

In order to solve such a problem attributable to a transition time, in the conventional apparatus and method disclosed in Document 1, a shutter is provided on the optical path of refractive index change inducing light, and the shutter is closed during a transition time to prevent an optical waveguide from being irradiated with the refractive index change inducing light during the transition time. However, it is still difficult to manufacture an optical waveguide type diffraction grating device having optical characteristics in compliance with its design even if such a shutter is provided. Because, as considering a delay time of control over the opening and closing of the shutter, it is difficult to control the opening and closing of the shutter in synchronism with a scan or vibration when irradiated positions are scanned at a high speed or the frequency of the vibration is high.

The invention has been made to solve the above-described problem, and it is an object of the invention to provide an apparatus and a method, which make it possible to manufacture an optical waveguide type diffraction grating device having desired optical characteristics easily.

A method of manufacturing an optical waveguide type diffraction grating device according to the present invention is directed to a method of manufacturing an optical waveguide type diffraction grating device comprising an optical waveguide, and a diffraction grating as refractive index modulation formed over a predetermined range of the optical waveguide in a longitudinal direction thereof. The method according to the present invention comprises the steps of: arranging a phase grating mask beside the optical waveguide; irradiating the optical waveguide with refractive index change inducing light through the phase grating mask while scanning the irradiating position of the refractive index change inducing light plural times in the longitudinal direction; relatively displacing the phase grating mask longitudinally in the direction opposite to each other from a reference relative position of the phase grating mask relative to the optical waveguide, every scan among the plurality of scans; and forming a diffraction grating as refractive index modulation in the optical waveguide to manufacture the optical waveguide type diffraction grating device.

An apparatus for manufacturing an optical waveguide type diffraction grating device according to the present invention is directed to an apparatus for manufacturing an optical waveguide type diffraction grating device comprising an optical waveguide, and a diffraction grating as refractive index modulation formed over a predetermined range of the optical waveguide in a longitudinal direction thereof. The apparatus according to the present invention comprises phase grating mask-displacing means, refractive index change inducing light radiating means, and displacement controlling means. The phase grating mask-displacing means displaces a phase grating mask arranged beside the optical waveguide in the longitudinal direction relative to the optical waveguide. The refractive index change inducing light radiating means irradiates the optical waveguide with refractive index change inducing light through the displaced phase grating mask while scanning the irradiating position of the refractive index change inducing light plural times in the longitudinal direction. The displacement controlling means controls the phase grating mask displacing means such that the phase grating mask is relatively displaced longitudinally in the direction opposite to each other from a reference relative position of the phase grating mask relative to the optical waveguide, every scan among the plurality of scans. The phase grating mask-displacing means preferably causes relative displacement of the phase grating mask by using a piezoelectric element.

In accordance with the apparatus or method of manufacturing an optical waveguide type diffraction grating device according to the present invention, the phase grating mask is provided beside the optical waveguide (which is a silica-based optical fiber whose core region is doped with GeO₂, for example), and the phase grating mask is displaced relative to the optical waveguide in the longitudinal direction thereof. The optical waveguide is irradiated with refractive index change inducing light (e.g., ultraviolet laser light) through the displaced phase grating mask, and the irradiating position of the refractive index change inducing light is scanned plural times in the longitudinal direction. Every scan among the plurality of scans, the phase grating mask is relatively displaced longitudinally in the direction opposite to each other from a reference relative position of the phase grating mask relative to the optical waveguide. In this manner, refractive index modulation is formed in the optical waveguide as a diffraction grating, and an optical waveguide type diffraction grating device is thus manufactured. Amplitudes of the refractive index modulation formed at this time depend on displacements of the phase grating mask relative to the optical waveguide.

In the method of manufacturing an optical waveguide type diffraction grating device according to the present invention, the phase grating mask is preferably displaced by a relative displacement corresponding to the irradiating position of the refractive index change inducing light during each of the plurality of scans. Also, in the apparatus for manufacturing an optical waveguide type diffraction grating device according to the present invention, the displacement controlling means preferably controls the phase grating mask displacing means such that the phase grating mask is displaced by a displacement corresponds to the irradiating position of the refractive index change inducing light during each of the plurality of scans. In this case, since the relative displacement of the phase grating mask is controlled in accordance with the irradiating position of the refractive index change inducing light, the amplitude of refractive index modulation formed in the optical waveguide type diffraction grating device may have a distribution in the longitudinal direction of the optical waveguide and may have for example a phase-inverted portion.

In the method of manufacturing an optical waveguide type diffraction grating device according to the present invention, it is preferable that the phase grating mask is relatively displaced only in either direction from the reference relative position during each of the plurality of scans. Also, in the apparatus for manufacturing an optical waveguide type diffraction grating device according to the present invention, the displacement controlling means preferably controls the phase grating mask displacing means such that the phase grating mask is relatively displaced only in either direction from the reference relative position during each of the plurality of scans.

In the method of manufacturing an optical waveguide type diffraction grating device according to the present invention, it is preferable that the scanning of the irradiating position of the refractive index change inducing light is performed an even number of times, that the phase grating mask is relatively displaced along a first direction from the reference relative position at odd-numbered scans among the even number of scans, and that the phase grating mask is relatively displaced along a second direction from the reference relative position at even-numbered scans. Also, in the apparatus for manufacturing an optical waveguide type diffraction grating device according to the present invention, it is preferable that the refractive index change inducing light radiating means preferably scans the irradiating position of the refractive index change inducing light an even number of times, that the displacement controlling means preferably controls the phase grating mask displacing means such that the phase grating mask is relatively displaced along a first direction from the reference relative position at odd-numbered scans among the even number of scans, and that the phase grating mask is relatively displaced along a second direction from the reference relative position at even-numbered scans.

An optical waveguide type diffraction grating device according to the present invention can be manufactured by the above-mentioned apparatus and method of manufacturing an optical waveguide type diffraction grating device according to the present invention. Namely, the device according to the present invention comprises an optical waveguide, and a diffraction grating as refractive index modulation formed over a predetermined range of the optical waveguide in the longitudinal direction thereof. In this optical waveguide type diffraction grating device, the amplitude distribution of refractive index modulation is appropriately designed in the longitudinal direction, and the amplitude distribution of refractive index modulation includes a phase-inverted portion, for example. Thus, the optical waveguide type diffraction grating device is capable of selectively reflecting, for example, multiplexed light, and it has high optical characteristics and reduced chromatic dispersion.

Also, the optical waveguide type diffraction grating device according to the present invention comprises a diffraction grating as refractive index modulation formed over a predetermined range of an optical waveguide in the longitudinal direction thereof, wherein the reflectance of a reflection peak in a band other than a Bragg reflection wavelength band based on a fundamental period of the refractive index modulation is −30 dB or less. In other words, there is no reflection peak having a reflectance of −30 dB or more in any band other than the Bragg reflection wavelength band. Furthermore, the maximum reflectance of the Bragg reflection wavelength band is preferably 90% or more.

A multiplexing/demultiplexing module according to the present invention includes an optical waveguide type diffraction grating device according to the present invention as described above, and it selectively reflects light having a reflection wavelength with the optical waveguide type diffraction grating device to multiplex or demultiplex the light. Further, the optical transmission system according to the present invention is directed to an optical transmission system for transmitting multiplexed signal light having plural wavelengths different from each other, and it includes the above-mentioned multiplexing/demultiplexing module according to the present invention and multiplexes or demultiplexes the multiplexed signal light with the multiplexing/demultiplexing module.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view showing a configuration of an optical waveguide type diffraction grating device of one embodiment according to the present invention;

FIG. 2 is a view showing a configuration of an apparatus of manufacturing an optical waveguide type diffraction grating device of an embodiment according to the present the invention;

FIG. 3 is a graph showing a relationship between displacements a of a phase grating mask and amplitudes F of refractive index modulation;

FIG. 4A is a graph showing displacements of a phase grating mask in positions z of an optical waveguide, and FIG. 4B is a graph showing amplitudes of refractive index modulation in the positions z;

FIGS. 5A and 5B are graphs for explaining displacements of the phase grating mask in an apparatus and a method of manufacturing an optical waveguide type diffraction grating device according to a comparative example, and FIGS. 5C and 5D are graphs explaining displacements of the phase grating mask in an apparatus and a method of manufacturing an optical waveguide type diffraction grating device according to the present invention;

FIGS. 6A and 6B are graphs for respectively explaining an example of displacements of the phase grating mask in the apparatus and the method of manufacturing an optical waveguide type diffraction grating device according to the present invention and the comparative example;

FIG. 7 is a view showing an amplitude distribution of refractive index modulation, which was intended to be achieved in designing each of the optical waveguide type diffraction grating devices according to the present invention and the comparative example;

FIG. 8A is a graph showing transmission characteristic of the optical waveguide type diffraction grating devices according to the comparative example, and FIG. 8B is a magnified view of FIG. 8A;

FIG. 9A is a graph showing reflection characteristic of the optical waveguide type diffraction grating device according to the comparative example, and FIG. 9B is a magnified view of FIG. 9A;

FIG. 10A is a graph showing transmission characteristic of the optical waveguide type diffraction grating devices according to the present invention, and FIG. 10B is a magnified view of FIG. 10A;

FIG. 11A is a graph showing reflection characteristic of the optical waveguide type diffraction grating device according to the present invention, and FIG. 11B is a magnified view of FIG. 11A;

FIG. 12 is a view showing a configuration of a multiplexing/demultiplexing module of a first embodiment according to the present invention;

FIG. 13 is a view showing a configuration of a multiplexing/demultiplexing module of a second embodiment according to the present invention;

FIG. 14 is a view showing a configuration of a multiplexing/demultiplexing module of a third embodiment according to the present invention; and

FIG. 15 is a view showing a configuration of an optical is transmission system of one embodiment according to the present invention.

### DETAILED DESCRIPTION OF THE PREFERRED EMBODIMENTS

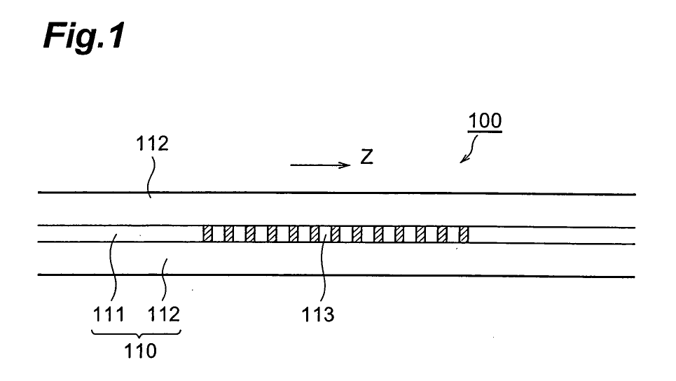

In the following, embodiments of an optical waveguide type diffraction grating device, a method of manufacturing the same, and an apparatus for manufacturing the same according to the present invention will be explained in detail with reference to FIGS. 1 to 3, 4A to 6B, 7, 8A to 11B and 12 to 15. In the explanation of the drawings, constituents identical to each other will be referred to with numerals identical to each other without repeating their overlapping descriptions.

First, an embodiment of an optical waveguide type diffraction grating device according to the present invention will be described. FIG. 1 is a view showing a configuration of an optical waveguide type diffraction grating device 100 of one embodiment according to the present invention. FIG. 1 shows a sectional view of the optical waveguide type diffraction grating device 100 taken along a plane including an optical axis thereof. The optical waveguide type diffraction grating device 100 is obtained by forming a diffraction grating 113 on an optical fiber 110 provided as an optical-waveguide. The optical fiber 110 is mainly composed of silica glass, and it comprises a core region 111 doped with GeO₂ and extending along the optical axis, and a cladding region 112 provided on the outer periphery of the core region 111. A diffraction grating 113 as refractive index modulation is formed over a predetermined range (hereinafter referred to as “refractive index modulation forming area”) in the longitudinal direction of the optical fiber 110.

A z-axis is set in the longitudinal direction of the optical fiber 110, and the origin of the z-axis is assumed to be the center of the refractive index modulation forming area. The grating spacing (grating period) of refractive index modulation formed in the refractive index modulation forming area is a constant value λ, and distribution n(z) of refractive indices of the diffraction grating 113 is expressed by the following expression (1).

$$n ( z ) = {n}_{0} + F ( z ) \cdot cos ( \frac{2 π}{Λ} z ) \qquad ( 1 )$$

where nₒ is an average effective refractive index of the optical fiber 110 in the refractive index modulating area; F(z) represents the distribution of amplitudes of refractive index modulation in the refractive index modulation forming area, the distribution being a sine function or cosine function, for example. The optical waveguide type diffraction grating device 100 can selectively reflect a light component having a Bragg reflection wavelength λ (=2nₒλ) by using the diffraction grating 113. By optimizing the distribution F(z) of amplitude of refractive index modulation, the chromatic dispersion of the optical waveguide type diffraction grating device 100 can be suppressed or made constant, or the device 100 can selectively reflect signal light with a plurality of wavelengths.

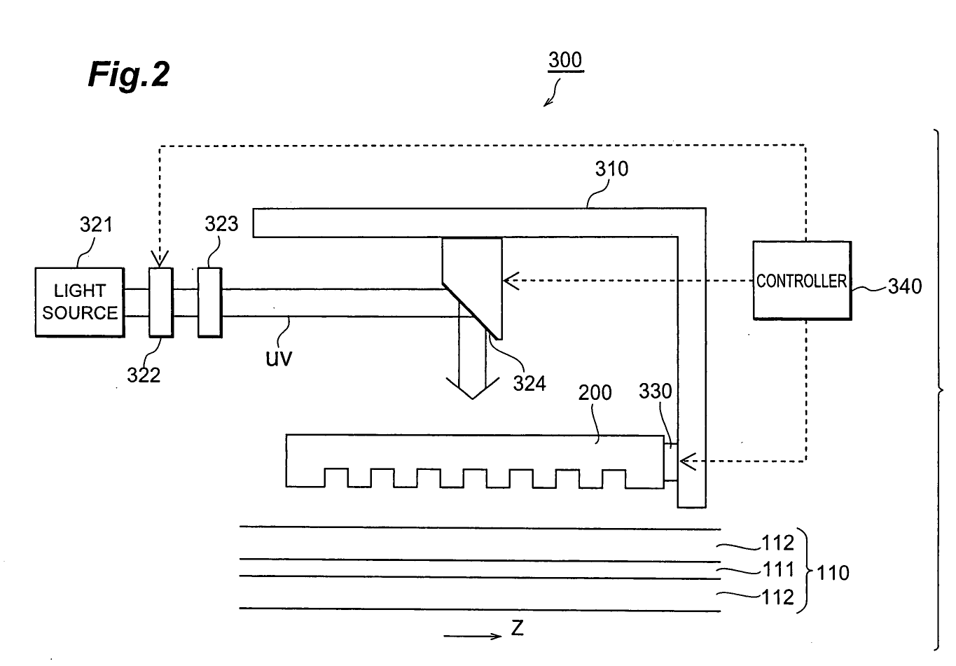

Next, an embodiment of an apparatus for manufacturing an optical waveguide type diffraction grating device according to the present invention will now be described. FIG. 2 is a view showing a configuration of an apparatus 300 for manufacturing an optical waveguide type diffraction grating device of one embodiment according to the present invention. The apparatus 300 for manufacturing an optical waveguide type diffraction grating device is preferably used in combination with the phase grating mask 200 when manufacturing an optical waveguide type diffraction grating device 100 as described above.

The apparatus 300 for manufacturing an optical waveguide type diffraction grating device comprises a fixing member 310, a light source 321, a shutter 322, an optical system 323, a mirror 324, a piezoelectric element 330, and a control section 340. Among those elements, the light source 321, the shutter 322, the optical system 323, and the mirror 324 constitute means for radiating refractive index change inducing light for irradiating an optical fiber 110 with refractive index change inducing light through the phase grating mask 300. The piezoelectric element 330 constitutes phase grating mask-displacing means for displacing the phase grating mask 200 that is provided beside the optical fiber 110 in the direction of a z-axis relative to the optical fiber 110. The control section 340 constitutes displacement control means for controlling the piezoelectric element 330, which causes relative displacement of the phase grating mask 200.

The light source 321 outputs refractive index change inducing light UV having a wavelength capable of inducing a change of the refractive index of the optical fiber 110 in the core region 111. As the light source 321, for example, it is preferable to use a KrF excimer laser light source outputting laser beam with a wavelength of 248 nm as the refractive index change inducing light UV. The shutter 322 is provided between the light source 321 and the mirror 324 to control passing/blocking of the refractive index change inducing light V outputted from the light source 321. Acoustooptic element is preferably used as the shutter 322, whereby the control over passing/blocking of the refractive index change inducing light UV is performed at a high speed.

The optical system 323 is provided between the shutter 322 and the mirror 324 to keep the luminous flux width of the refractive index change inducing light UV in the direction of the z-axis at a predetermined value (which is preferably 500 μm or less and, more preferably, 100 μm or less) when the optical fiber 110 is irradiated with the refractive index change inducing light UV. As the optical system 323, a condenser lens is preferably used. Alternatively, an aperture having a predetermined aperture width is also preferably used. In the case that a condenser lens is used as the optical system 323, since the energy of the refractive index change inducing light UV is effectively utilized, whereby an excellent diffraction grating producing efficiency is attained. Also, in the case that an aperture is used as the optical system 323, mechanical damage to the optical fiber 110 is reduced.

The mirror 324 has a reflecting surface, which is inclined at 45 degrees with respect to the direction of the z-axis and reflects refractive index change inducing light UV, which has propagated in the direction of the z-axis through the optical system 323, in a direction perpendicular to the z-axis. The mirror 324 irradiates the optical fiber 310 with the reflected refractive index change inducing light UV through the phase grating mask 200. The mirror 324 is fixed to the fixing member 310 so as to be movable along the z-axis.

The phase grating mask 200 is a flat plate of silica glass having one face formed with a phase grating having a grating spacing 2λ on one surface thereof, and is arranged such that the surface having the phase grating formed thereon faces the optical fiber 110. The grating spacing of the phase grating mask 200 is twice that of a grating spacing λ of a diffraction grating 113 to be formed in the optical fiber 110. The phase grating mask 200 is fixed on the fixing member 310 through the piezoelectric element 330 interposed between them, and it can be displaced in the direction of the z-axis by the action of the piezoelectric element 330.

The control section 340 moves the mirror 324 in the direction of the z-axis relative to the fixing member 310. Thus, the control section 340 scans the irradiating position of the refractive index change inducing light UV on the optical fiber 110 plural times over a predetermined range (a refractive index modulation forming area) of the optical fiber 110. At this time, the control section 340 preferably scans the irradiating position of the refractive index change inducing light UV at a constant speed. In this case, an average effective refractive index in the refractive index modulation forming area of the optical fiber 110 becomes uniform in the longitudinal direction.

The control section 340 controls the piezoelectric element 330 to displace the phase grating mask 200 in the direction of the z-axis relative to the optical fiber 110. During each scan of the plurality of scans of the irradiating position, the phase grating mask 200 is relatively displaced oppositely in the direction of the z-axis from a reference relative position of the phase grating mask 200 relative to the optical fiber 110. More specifically, when it is assumed that the irradiating position is scanned an even number of times, the phase grating mask 200 is relatively displaced in a +z direction with respect to the reference relative position during odd-numbered scans, and the phase grating mask 200 is displaced in a −z direction from the reference relative position during even-numbered scans. Thus, amplitudes of refractivity modulation formed on the optical fiber 110 are adjusted. In particular, the control section 340 preferably controls the displacement of the phase grating mask 200 according to irradiating positions z of the of the refractive index change inducing light UV. In this case, the amplitude F(z) of refractive index modulation corresponds to the displacement of the phase grating mask 200 at each position z. Thus, an optical waveguide type diffraction grating device 100 having desired optical characteristics can be manufactured.

The control section 340 preferably makes the displacement of the phase grating mask 200 equal to ¼ of the grating spacing λ of the diffraction grating 113 to be formed on the optical fiber 110 at any position zₒ within a predetermined range of the optical fiber 110. In this case, the amplitude distribution function f(z) of refractivity index modulation has a phase-inverted portion in the position zₒ, and the optical characteristics of the optical waveguide type diffraction grating device 110 are further improved.

Next, operations of the apparatus 300 for manufacturing an optical waveguide type diffraction grating device according to the present invention will now be described, and a method of manufacturing an optical waveguide type diffraction grating device according to the present invention will be also described. The apparatus 300 for manufacturing an optical waveguide type diffraction grating device operates as follows under control of the control section 340.

The refractive index change inducing light UV outputted from the light source 321 is made incident on the mirror 324 through the shutter 322 and the optical system 323, and the light is reflected by the mirror 324 and irradiates the optical fiber 110 through the phase grating mask 200. At this time, +1st-order diffracted beam and 1st-order diffracted beam are generated as a result of diffraction at the phase grating mask 200 having the grating spacing 2λ, and the two diffracted beams interfere each other to generate interference fringes having fringe spacing λ. The mirror 324 moves over a predetermined area in the direction of the z-axis to scan the irradiating position of the refractive index change inducing light UV on the optical fiber 110 through the phase grating mask 200 plural times. Refractive index modulation having a grating spacing λ is formed in the core region 111 of the optical fiber 110 in accordance with the spatial distribution of the optical energy of the interference fringes, whereby a diffraction grating is thus formed.

During the movement of the mirror 324 and the irradiation with the refractive index change inducing light UV, the phase grating mask 200 is displaced in the direction of the z-axis by the action of the piezoelectric element 330. In the case that the irradiating position is scanned twice, a₁(z) represents the relative displacement of the phase grating mask 200 in an irradiating position z at the first scan, and a₂(z) represents the relative displacement of the phase grating mask 200 in the irradiating position z at the second scan. The relative displacement a₁(z) is 0 or more, and the relative displacement a₂(z) is 0 or less. It is also assumed that the absolute values of the relative displacements a₁(z) and a₂(z) in each position z are equal to each other.

The distribution of refractive indices of the diffraction grating 113 formed by the irradiation with the refractive index change inducing light U at this time is expressed by the following expression (2).

$$\begin{matrix}n ( z ) = {n}_{0} + \frac{1}{2} Δ {n}_{0} \{ cos ( \frac{2 π}{Λ} ( z - a ) ) + cos ( \frac{2 π}{Λ} ( z + a ) ) \} \\ = {n}_{0} + Δ {n}_{0} \cdot cos ( \frac{2 π}{Λ} a ) \cdot cos ( \frac{2 π}{Λ} z )\end{matrix} \qquad ( 2 )$$

Furthermore, an amplitude F(z) of refractive index modulation is expressed by the following expression (3).

$$F ( z ) = Δ {n}_{0} \cdot cos ( \frac{2 π}{Λ} a ) \qquad ( 3 )$$

where a represents the absolute value of the relative displacement of the phase grating mask 200, and Δnₒ represents a coefficient having a value corresponding to the irradiation amount (=irradiation intensity×irradiating time) of the refractive index change inducing light UV.

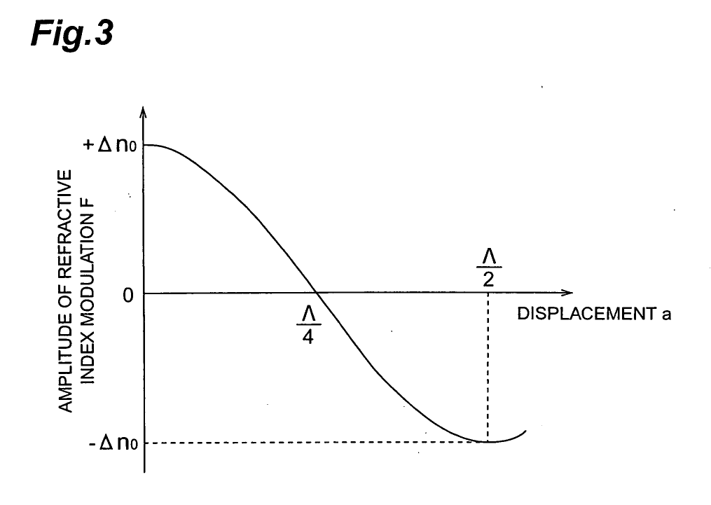

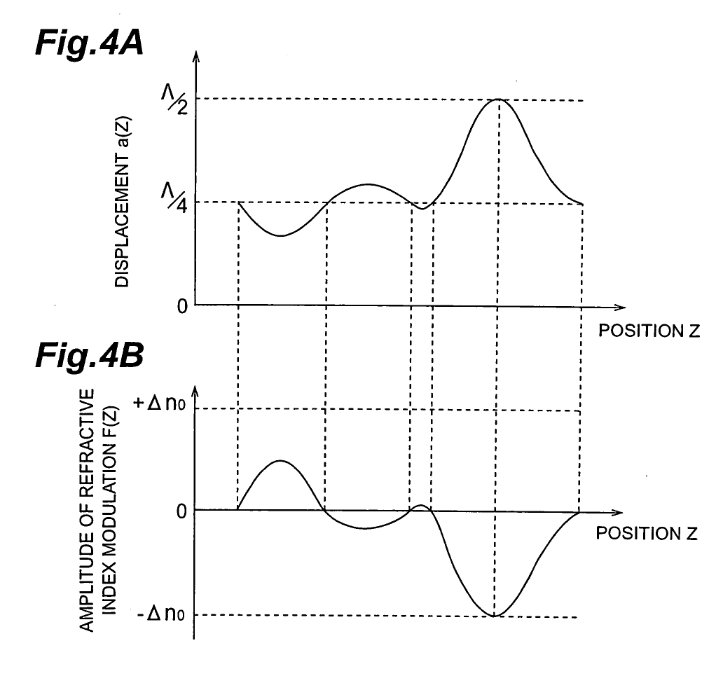

The third factor (cos(2πz/λ) of the second term on the right side of Expression (2) indicates that the grating spacing in the diffraction grating 113 is λ. The amplitude F(z) of refractive index modulation in Expression (3) is a function of the displacement a of the phase grating mask 200, and it has a value corresponding to the displacement a. Thus, the amplitude F(z) of refractive index modulation can be adjusted by controlling the relative displacement a of the phase grating mask 200 appropriately. Therefore, in order to obtain amplitudes F(z) of refractive index modulation as shown in FIG. 4B, the relative displacements a₁(z) and a₂(z) of the phase grating mask 200 at each position z may be controlled as shown in FIG. 4B based on Expression 3. Here, FIG. 3 is a graph showing a relationship between displacements a of a phase grating mask and amplitudes F of refractive index modulation. FIG. 4A is a graph showing displacements of a phase grating mask in positions z of an optical waveguide, and FIG. 4B is a graph showing amplitudes of refractive index modulation in the positions z.

As shown in FIG. 3, the amplitude F(z) of refractive index modulation is positive when the displacement a of the phase grating mask 200 is in the range from 0 to λ/4, and the amplitude F(z) of refractive index modulation is negative when the displacement a of the phase grating mask 200 is in the range from λ/4 to 3λ/4. That is, when the displacement a of the phase grating mask 200 is λ/4 in a certain position zₒ and a change in displacement a from a value smaller than λ/4 to a value greater than λ/4 (and vice versa) occurs across the position zₒ, the amplitude F(z) of refractive index has a phase-inverted portion in the position zₒ (see FIGS. 4A and 4B).

Furthermore, in order to obtain such an amplitude distribution F(z) of refractivity index modulation, the luminous flux width of the refractive index change inducing light UV incident upon the phase grating mask 200 in the direction of the z-axis is preferably set at 500 μm or less (more preferably 100 μm or less) using the optical system 323. The mirror 324 is preferably moved at a constant speed in the direction of the z-axis. As the mirror 324 is moved (or the irradiating position z of the refractive index change inducing light U is scanned) at a constant speed, the phase grating mask 200 is displaced in the direction of the z-axis by displacements a₁(z) and a₂(z) according to the irradiating position z. When the intensity of the refractive index change inducing light UV is constant and the irradiating position z is scanned at a constant speed, the average effective refractive index in the refractive index modulation forming area of the optical fiber 110 becomes uniform in the direction of the z-axis.

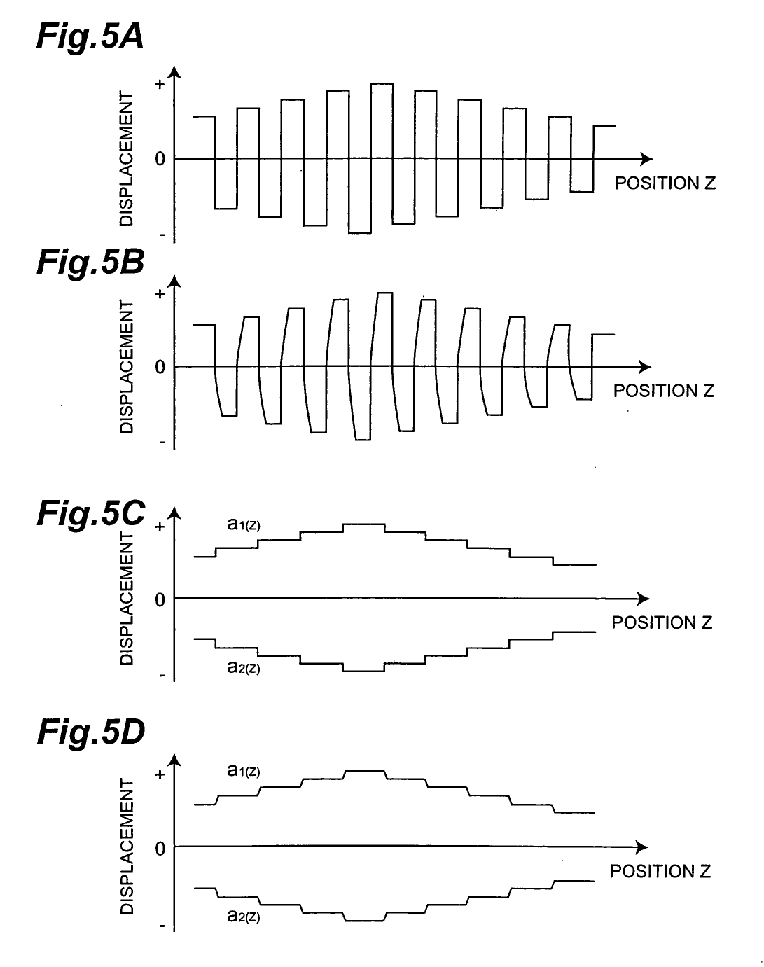

FIGS. 5A to 5D are graphs showing displacements of the phase grating mask 200. Specifically, FIG. 5A shows idealistic displacements of a phase grating mask in a comparative example, and FIG. 5B shows actual displacements of the phase grating mask in the comparative example. FIG. 5C shows idealistic displacements of the phase grating mask in the embodiment according to the present invention, and FIG. 5D shows actual displacements of the phase grating mask in the embodiment according to the present invention. In each of FIGS. 5A to 5D, the abscissa axis represents positions z in the longitudinal direction of the optical fiber 110, and the ordinate axis represents relative displacements of the phase grating mask 200. The relative displacement of the phase grating mask 200 is 0 in the reference relative position of the phase grating mask 200 relative to the optical fiber 110.

In the comparative example, the phase grating mask vibrates relative to the optical fiber in the longitudinal direction thereof as the scanning of the irradiating position of the refractive index change inducing light proceeds. Idealistically, the movement of the phase grating mask from one displaced position to another displaced position instantaneously takes place as shown in FIG. 5A. In practice, however, a certain transition time is required for the movement of the phase grating mask from the one displaced position to the other displaced position as shown in FIG. 5B. The transition time causes the waveform of the vibration of the phase grating mask different from the one to be intended. When the irradiated positions are scanned at a high speed or when the vibration frequency is high, the influence of the transition time on the irradiation with refractive index change inducing light becomes too significant to ignore, and there will be great differences between the optical characteristics of an optical waveguide type diffraction grating device thus manufactured and designed values of the same.

On the contrary, in the embodiment of the present invention, the phase grating mask is relatively displaced only to either side of the reference relative position at each scan of the irradiating position of the refractive index change inducing light instead of being vibrated relative to the optical fiber in the longitudinal direction thereof. Idealistically, both of the relative displacement a₁(z) of the phase grating mask during the first scans and the relative displacement a₂(z) of the phase grating mask during the second scans undergo stepwise changes as shown in FIG. 5C. In practice, however, a certain transition time is required for the phase grating mask to move from a certain displaced position from another displaced position with respect to both of the relative displacements a₁(z) or a₂(z), as shown in FIG. 5D. In comparison to the comparative example, however, a transition time occupies a smaller percentage of a scan time in the present embodiment, and there is a smaller difference between an actual displaced position reached in the transition time and an idealistic displaced position.

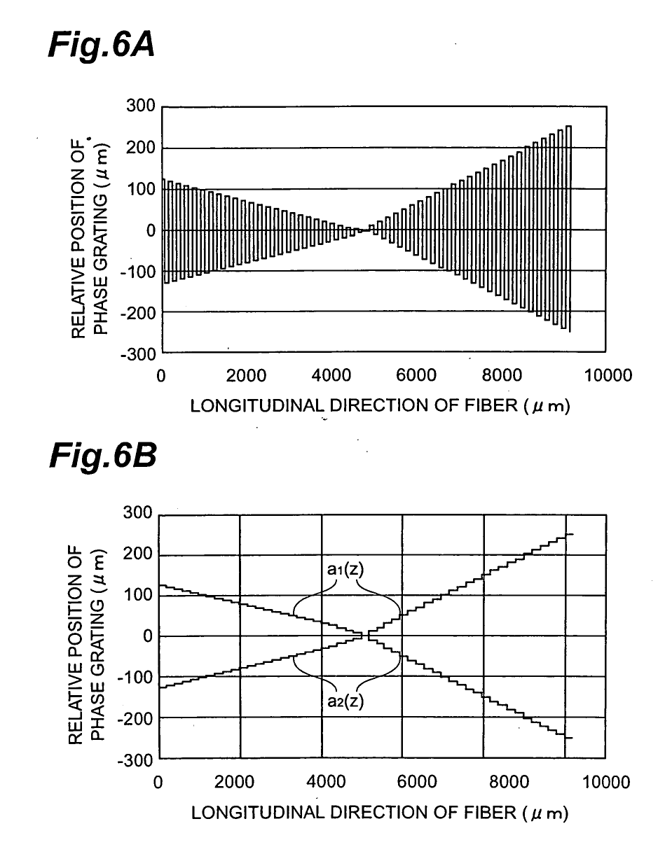

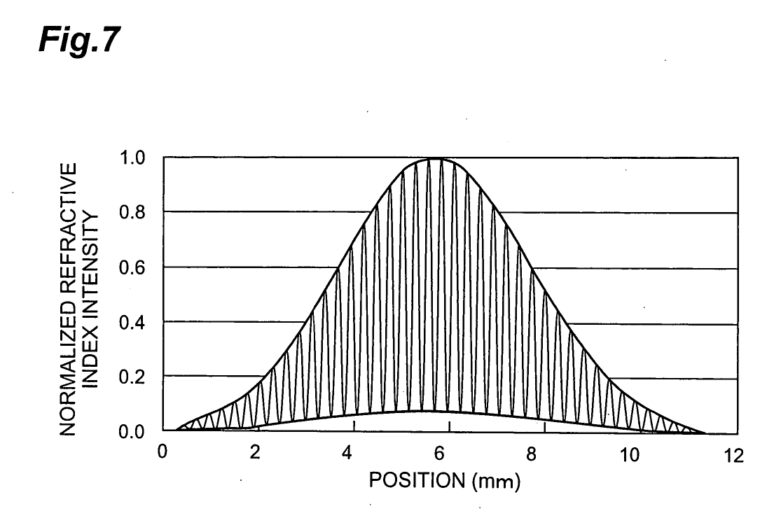

FIGS. 6A and 6B illustrate an example of displacements of the phase grating mask 200. Specifically, FIG. 6A shows displacements of a phase grating mask in a comparative example, and FIG. 6B shows displacements of the phase grating mask in the embodiment according to the present invention. In each of FIGS. 6A and 6B, the abscissa axis represents positions z in the longitudinal direction of the optical fiber 110, and the ordinate axis represents relative displacements of the phase grating mask 200. In the present embodiment, the phase grating mask is relatively displaced only to either direction of the reference relative position at each scan of the irradiating position of the refractive index change inducing light. Both of the relative displacement a₁(z) of the phase grating mask during the first scans and the relative displacement a₂(z) of the phase grating mask during the second scans undergo stepwise changes as shown in FIG. 6B.

As described above, in the present embodiment, even if there are transition times as described above when the irradiating position of the refractive index change inducing light is scanned at a high speed, the influence of the irradiation with the refractive index change inducing light during the transition times is small. It is therefore possible to scan the irradiating position of the refractive index change inducing light at a high speed and to thereby manufacture an optical waveguide type diffraction grating device having desired optical characteristics easily.

While the relative displacements a₁(z) and a₂(z) in the present embodiment have been shown as changing stepwise in FIGS. 5C, 5D and 6B, the steps may be made smaller to make changes in the longitudinal direction quasi-continuous. In the latter case, since the problem of transition times is further mitigated, the manufacture of an optical waveguide type diffraction grating device having desired optical characteristics can be further facilitated.

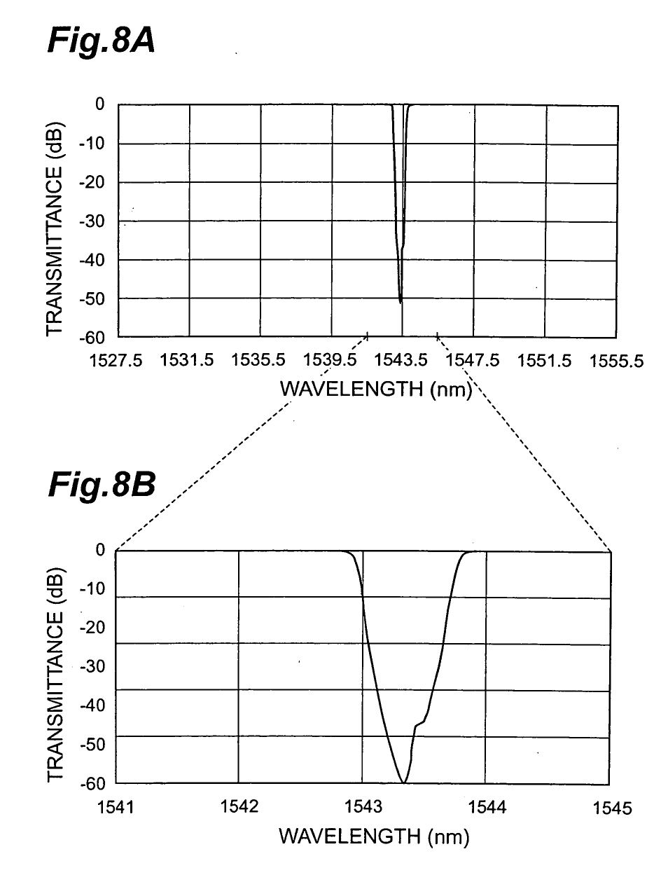

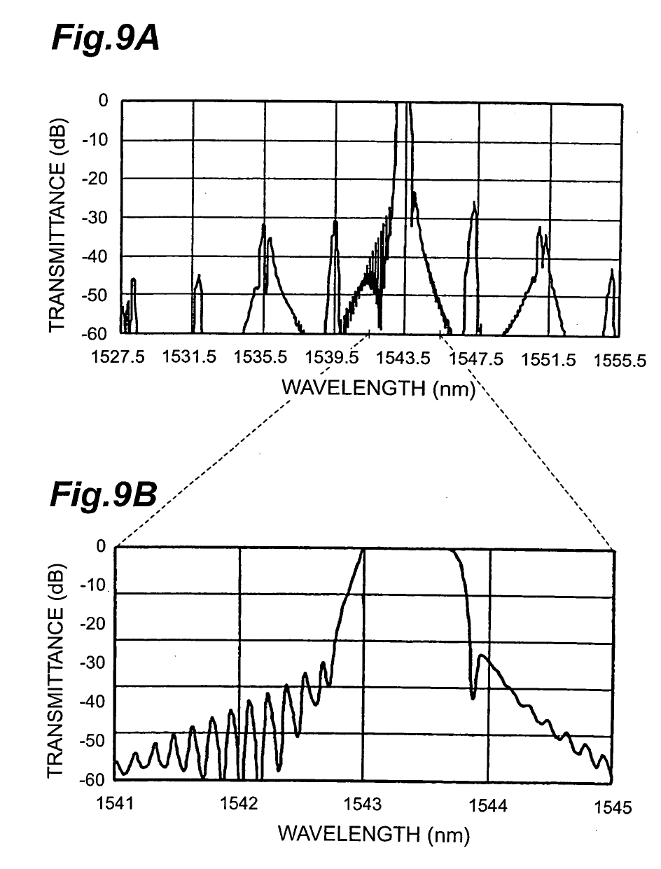

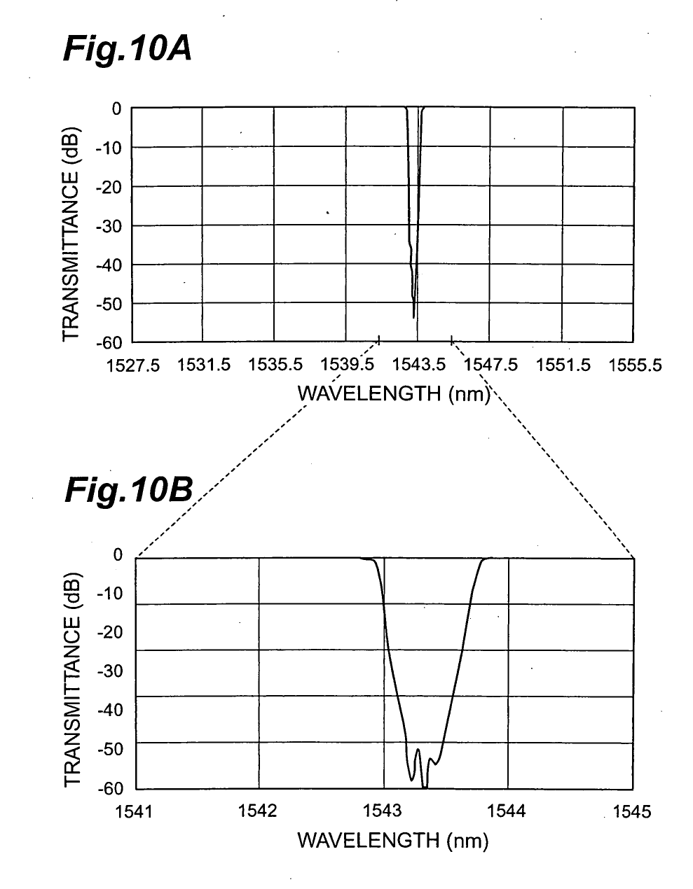

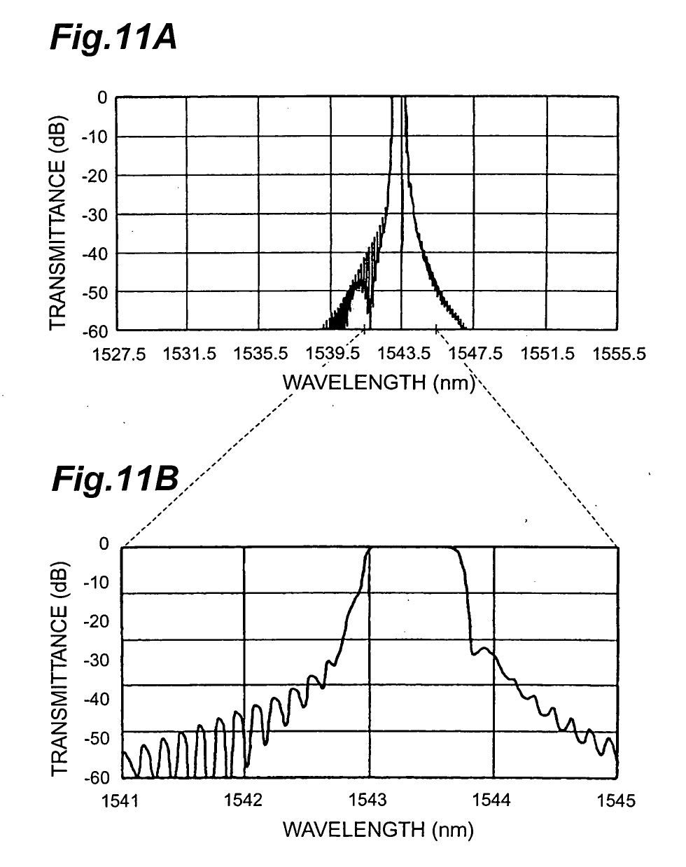

A description will now be made on an example of an optical waveguide type diffraction grating device manufactured according to the method of manufacturing an optical waveguide type diffraction grating device of the embodiment according to the present invention with reference to a comparative example. FIG. 7 shows an amplitude distribution of refractive index modulation, which was intended to be achieved in designing each of the optical waveguide type diffraction grating devices in the embodiment according to the present invention and the comparative example. FIG. 7 shows envelopes each connecting maximum values and minimum values of refractive index modulation, respectively. The shape of the designed amplitude distribution of refractive index modulation was a Gaussian function type, and it was intended to achieve a Bragg reflection wavelength band having a certain bandwidth centered at a Bragg reflection wavelength based on a fundamental period of refractive index modulation. Furthermore, FIG. 8A is a graph showing transmission characteristic of the optical waveguide type diffraction grating devices according to the comparative example, and FIG. 8B is a magnified view of FIG. 8A. FIG. 9A is a graph showing reflection characteristic of the optical waveguide type diffraction grating device according to the comparative example, and FIG. 9B is a magnified view of FIG. 9A. FIG. 10A is a graph showing transmission characteristic of the optical waveguide type diffraction grating devices according to the present invention, and FIG. 10B is a magnified view of FIG. 10A. Further, FIG. 11A is a graph showing reflection characteristic of the optical waveguide type diffraction grating device according to the present invention, and FIG. 11B is a magnified view of FIG. 11A.

In the comparative example, a phase grating mask was vibrated while scanning the irradiating position of refractive index change inducing light as shown in FIGS. 5A and 6A. As shown in FIGS. 8A to 9B, the Bragg reflection wavelength band based on the fundamental period of refractive index modulation was in the range from about 1543.0 nm to 1543.7 nm. In the comparative example, there were reflection peaks at wavelength intervals of about 4 nm, and the maximum reflectance of the reflection peaks was about −26 dB. The reflection peaks was not intended at the time of designing.

In this embodiment, a phase grating mask was displaced while scanning the irradiating position of refractive index change inducing light as shown in FIGS. 5C and 6B. As shown in FIGS. 10A to 11B, the Bragg reflection wavelength band based on the fundamental period of refractive index modulation was in the range from about 1543.0 nm to 1543.7 nm, and the embodiment was similar to the comparative example in this regard. In the embodiment, however, the reflectance R of reflection peaks in bands other than the Bragg reflection wavelength band was −30 dB or less. That is, there was neither reflection peak having a reflectance R of −30 dB or more nor reflection peak having a reflectance R of −60 dB or more in the bands other than the Bragg reflection wavelength band.

Although the “reflection peaks in bands other than the Bragg reflection wavelength band” includes reflection peaks at wavelength intervals of about 4 nm that are present in bands other than the Bragg reflection wavelength band as shown in FIGS. 8A and 9A, the definition excludes reflection peaks in bands which are in the neighborhood of the Bragg reflection wavelength band as shown in FIGS. 8B and 9B and FIGS. 10B and 11B and in which the reflectance R gradually decreases as a whole with the distance from the Bragg reflection wavelength while repeatedly increasing and decreasing.

The presence of the reflection peaks at constant wavelength intervals in bands other than the Bragg reflection wavelength band in the comparative example (FIGS. 8A to 9B) is considered attributable to the following reason. In the comparative example, since the phase grating mask is vibrated while scanning the irradiating position of the refractive index change inducing light, the actually formed refractive index modulation includes not only modulated components having the fundamental period λ as intended but also modulated components having a period different from the fundamental period λ because of the influence of irradiation with the refractive index change inducing light during transition times involved in the vibration. In particular, modulated components having a period VT different from the fundamental period λ are generated where V represents the scanning speed of the irradiating position of the refractive index change inducing light and T represents the period of the vibration of the phase grating mask. The modulated components having a period different from the fundamental period considered contributing to the presence of the reflection peaks at constant wavelength intervals in bands other than the Bragg reflection wavelength band.

On the contrary, in this embodiment (FIGS. 10A to 11B), it is considered that the generation of modulated components having a period different from the fundamental period is -suppressed to suppress reflection peaks in bands other than the Bragg reflection wavelength band because the phase grating mask is not vibrated when refractivity index modulation is formed. Thus, the method and apparatus for manufacturing an optical waveguide type diffraction grating device according to the embodiment make it possible to manufacture an optical waveguide type diffraction grating device having desired optical characteristics easily.

Embodiments of a multiplexing/demultiplexing module according to the present invention will now be described. An optical waveguide type diffraction grating device included in each of embodiments described below is an optical waveguide type diffraction grating device 100 according to the above-described embodiments. The amplitude distribution of refractive index modulation of the optical waveguide type diffraction grating device preferably has a phase-inverted portion. In this case, the absolute value of chromatic dispersion is small when light is reflected, which allows signal transmission at a high bit rate. For the convenience of description, it is assumed hereinafter that the optical waveguide type diffraction grating device 100 has M reflection bands; a wavelength λ₂ₘ exits in an m-th reflection band; and a wavelength length λ₂ₘ₋₁ exists in a transmission bands between reflection bands. The reference symbol m represents an integer in the range from 1 to M, and reference symbol M represents an integer equal to or greater than 2. The wavelengths satisfy a relational expression “λ₁<λ₂<λ₃< . . . λ_{2M-1}<λ_{2M}”.

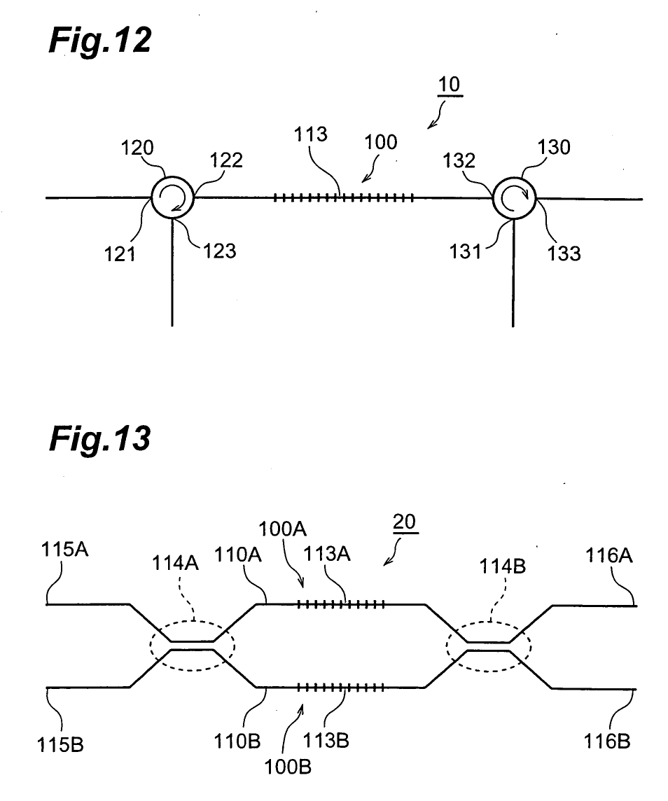

FIG. 12 is a view showing a configuration of a multiplexing/demultiplexing module 10 of a first embodiment according to the present invention. The multiplexing/demultiplexing module 10 is configured by connecting an optical circulator 120 to one end of an optical waveguide type diffraction grating device 100 and by connecting an optical circulator 130 to another end of the optical waveguide type diffraction grating device 100. The optical circulator 120 has a first terminal 121, a second terminal 122, and a third terminal 123, and it outputs light inputted to the first terminal 121 to the optical waveguide type diffraction grating device 100 from the second terminal 122 and outputs light inputted to the second terminal 122 from the third terminal 123. The optical circulator 130 has a first terminal 131, a second terminal 132, and a third terminal 133, and it outputs light inputted to the first terminal 131 to the optical waveguide type diffraction grating device 100 from the second terminal 132 and outputs light inputted to the second terminal 132 from the third terminal 133.

In this multiplexing/demultiplexing module 10, when light component having a wavelength λ₂ₘ₋₁ is inputted to the first terminal 121 of the optical circulator 120, the light component is outputted to the optical waveguide type diffraction grating device 100 from the second terminal 122 of the optical circulator 120. The light component, passing through the optical waveguide type diffraction grating device 100, is inputted to the second terminal 132 of the optical circulator 130, and is outputted from the third terminal 133 of the optical circulator 130. When light component having a wavelength λ₂ₘ is inputted to the first terminal 131 of the optical circulator 130, the light component is outputted to the optical waveguide type diffraction grating device 100 from the second terminal 132 of the optical circulator 130. These light components are outputted from the second terminal 132 of the optical circulator 130 to the optical waveguide type diffraction grating device 100, and there after they are reflected by the optical waveguide type diffraction grating device 100. Subsequently, these light components are inputted to the second terminal 132 of the optical circulator 130, and are outputted from the third terminal 133 of the optical circulator 130. That is, the multiplexing/demultiplexing module 10 operates as a multiplexer in this case. It multiplexes the light component having the wavelength λ₂ₘ₋₁ inputted to the first terminal 121 of the optical circulator 120 and the light component having the wavelength λ₂ₘ inputted to the first terminal 131 of the optical circulator 130, and outputs multiplexed light having wavelengths λ₁ to λ_{2M} from the third terminal 133 of the optical circulator 130. The optical circulator 120 is not required when the multiplexing/demultiplexing module 10 is used only as a multiplexer.

In this multiplexing/demultiplexing module 10, when light components having wavelengths λ₁ to λ_{2M} are inputted to the first terminal 121 of the optical circulator 120, the light components are output to the optical waveguide type diffraction grating device 100 from the second terminal 122 of the optical circulator 120. Among the light components, the light component having the wavelength λ₂ₘ are reflected by the optical waveguide type diffraction grating device 100, and is inputted to the second terminal 122 of the optical circulator 120. Thereafter, the light component is outputted from the third terminal 123 of the optical circulator 120. On the other hand, the light component having the wavelength λ₂ₘ₋₁ passes through the optical waveguide type diffraction grating device 100 to be inputted to the second terminal 132 of the optical circulator 130, and is outputted from the third terminal 133 of the optical circulator 130. That is, the multiplexing/demultiplexing module 10 operates as a demultiplexer in this case. It demultiplexes the light components having the wavelengths λ₁ to λ_{2M} inputted to the first terminal 121 of the optical circulator 120 to output the light component having the wavelength λ₂ₘ from the third terminal 123 of the optical circulator 120 and to output the light component having the wavelengths λ₂ₘ₋₁ from the third terminal 133 of the optical circulator 130. The optical circulator 130 is not required when the multiplexing/demultiplexing-module 10 is used only as a demultiplexer.

Further, the multiplexing/demultiplexing module 10 operates also as an optical ADM (Add-Drop Multiplexer) by operating as both multiplexer and demultiplexer. That is, the multiplexing/demultiplexing module 10 outputs (drops) the light component having the wavelength λ₂ₘ among the light components having wavelengths λ₁ to λ_{2M} inputted to the first terminal 121 of the optical circulator 120 from the third terminal 123 of the optical circulator 120 and inputs (adds) the light component having the wavelength λ₂ₘ and carrying other information to the first terminal 131 of the optical circulator 130. It multiplexes the light component having the wavelength λ₂ₘ₋₁ among the light components having the wavelengths λ to λ₂ₘ inputted to the first terminal 121 of the optical circulator 120 and the light component having the wavelength λ₂ₘ inputted to the first terminal 131 of the optical circulator 130, and thereafter outputs multiplexed light having wavelengths λ₁ to λ_{2M} from the third terminal 133 of the optical circulator 130.

FIG. 13 is a view showing a configuration of a multiplexing/demultiplexing module 20 of a second embodiment according to the present invention. In the multiplexing/demultiplexing module 20, an optical fiber 110A and an optical fiber 110B are optically coupled through optical couplers 114A and 114B, respectively. A diffraction grating 113A is formed in a predetermined range of the optical fiber 110A between the optical coupler 114A and the optical coupler 114B to provide an optical waveguide type diffraction grating device 100A, and a diffraction grating 113B is formed in a predetermined range of the optical fiber 110B between the optical coupler 114A and he optical coupler 114B to provide an optical waveguide type diffraction grating device 100B. Each of the optical waveguide type diffraction grating devices 100A and 100B is similar to the optical waveguide type diffraction grating device 100 described above.

In this multiplexing/demultiplexing module 20, when light component having a wavelength λ₂ₘ₋₁ is inputted to a first end 115A of the optical fiber 110A, the light component is branched by the optical coupler 114A and passes through the optical waveguide type diffraction grating devices 101A and 110B. Further, the light component with the wavelength λ₂ₘ₋₁ is multiplexed by the optical coupler 114B and is outputted from a second end 116A of the optical fiber 110A. When light component having a wavelength λ₂ₘ is inputted to a second end 116B of the optical fiber 110B, the light component is branched by the optical coupler 114B and is reflected by the optical waveguide type diffraction grating devices 100A and 110B. Subsequently, the light component with the wavelength λ₂ₘ is multiplexed by the optical coupler 114B and is outputted from the second end 116A of the optical fiber 110A. That is, the multiplexing/demultiplexing module 20 operates as a multiplexer in this case. It multiplexes the light component having the wavelength λ₂ₘ₋₁ inputted to the first end 115A of the optical fiber 110A and the light component having the wavelength λ₂ₘ inputted to the second end 116B of the optical fiber 110A, and outputs multiplexed light having wavelengths λ₁ to λ_{2M} from the second end 116A of the optical finer 110A.

In this multiplexing/demultiplexing module 20, when light components having wavelengths λ₁ to λ_{2M} are inputted to the first end 115A of the optical fiber 110A, the light component is branched by the optical coupler 114A and is outputted to the optical waveguide type diffraction grating devices 100A and 110B. Among the light components, the light component having the wavelength λ₂ₘ is reflected by the optical waveguide type diffraction grating devices 100A and 110B, and is multiplexed by the optical coupler 114A. Thereafter the light with the wavelength λ₂ₘ is outputted from a first end 115B of the optical fiber 110B. On the other hand, the light component having the wavelength λ₂ₘ₋₁ passes through the optical waveguide type diffraction grating devices 100A and 110B and is multiplexed by the optical coupler 114B. And, the light component with the wavelength λ₂ₘ₋₁ is outputted from the second end 116A of the optical fiber 110A. That is, the multiplexing/demultiplexing module 20 operates as a demultiplexer in this case. It demultiplexes the light components having wavelengths λ₁ to λ_{2M} inputted to the first end 115A of the optical fiber 110A to output the light component having the wavelength λ₂ₘ from the first end 115B of the optical fiber 110B and to output the light component having the wavelengths λ₂ₘ₋₁ from the second end 116A of the optical fiber 110A.

Further, the multiplexing/demultiplexing module 20 operates also as an optical ADM by operating as both multiplexer and demultiplexer. That is, the multipiexing/demultiplexing module 20 outputs (drops) the light component having the wavelength λ₂ₘ among the light component having wavelengths λ₁ to λ_{2M} inputted to the first end 115A of the optical fiber 110A from the first end 115B of he optical fiber 110B and inputs (adds) the light component having the wavelength λ₂ₘ and carrying other information to the second end 116B of the optical fiber 110B. It multiplexes the light component having the wavelength λ₂ₘ₋₁ among the light component having the wavelengths λ₁ to λ₂ₘ inputted to the first end 115A of the optical fiber 110A and the light component having the wavelength λ₂ₘ inputted to the second end 116B of the optical fiber 110B, and outputs multiplexed light having wavelengths λ₁ to λ_{2M} from the second end 116A of the optical fiber 110A.

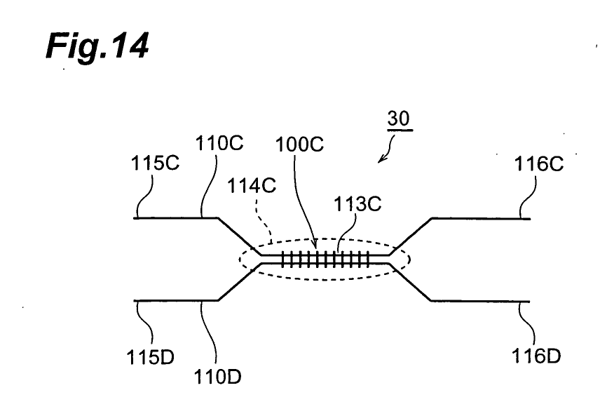

FIG. 14 is a view showing a configuration of a multiplexing/demultiplexing module 30 of a third embodiment according to the present invention. In the multiplexing/demultiplexing module 30, an optical fiber 110C and an optical fiber 110D are optically coupled through an optical coupler 114C, and a diffraction grating 113C is formed in a predetermined range of a portion of the optical coupler 114C where the optical fiber 110C and the optical fiber 110D are fusion-spliced to provide an optical waveguide type diffraction grating device 100C. The optical waveguide type diffraction grating device 100C is similar to the optical waveguide type diffraction grating device 100 described above. The diffraction grating 110C is formed in core regions of both of the optical fiber 110C and the optical fiber 110D.

In this multiplexing/demultiplexing module 30, when light component having a wavelength λ₂ₘ₋₁ is inputted to a first end 115C of the optical fiber 110C, the light component passes through the optical waveguide type diffraction grating device 100C and is outputted from a second end 116C of the optical fiber 110C. When light component having a wavelength λ₂ₘ is inputted to a second end 116D of the optical fiber 110D, the light component is reflected by the optical waveguide type diffraction grating device 100C and is outputted from the second end 116C of the optical fiber 110C. That is, the multiplexing/demultiplexing module 30 operates as a multiplexer in this case. It multiplexes the light component having the wavelength λ₂ₘ₋₁ inputted to the first end 115C of the optical fiber 110C and the light component having the wavelength λ₂ₘ inputted to the second end 116D of the optical fiber 110D, and outputs multiplexed light having wavelengths λ₁ to λ_{2M} from the second end 116C of the optical finer 110C.

In this multiplexing/demultiplexing module 30, when light components having wavelengths λ₁ to λ_{2M} are inputted to the first end 115C of the optical fiber 110C, the light components reach the optical waveguide type diffraction grating device 100C. Among the light components, the light component having the wavelength λ₂ₘ is reflected by the optical waveguide type diffraction grating device 100C and is outputted from a first end 115D of the optical fiber 110D. The light component having the wavelength λ₂ₘ₋₁ passes through the optical waveguide type diffraction grating device 100C and is outputted from the second end 116C of the optical fiber 110C. That is, the multiplexing/demultiplexing module 30 operates as a demultiplexer in this case. It demultiplexes the light components having wavelengths λ₁ to λ_{2M} inputted to the first end 115C of the optical fiber 110C to output the light component having the wavelength λ₂ₘ from the first end 115D of the optical fiber 110D and to output the light component having the wavelengths λ₂ₘ₋₁ from the second end 116C of the optical fiber 110C.

Further, the multiplexing/demultiplexing module 30 operates also as an optical ADM by operating as both multiplexer and demultiplexer. That is, the multiplexing/demultiplexing module 30 outputs (drops) the light component having the wavelength λ₂ₘ among the light components having wavelengths λ₁ to λ_{2M} inputted to the first end 115C of the optical fiber 110C from the first end 115D of he optical fiber 110D and inputs (adds) the light component having the wavelength λ₂ₘ and carrying other information to the second end 116D of the optical fiber 110D. It multiplexes the light component having the wavelength λ₂ₘ₋₁ among the light components having the wavelengths λ₁ to λ_{2M} inputted to the first end 115C of the optical fiber 110C and the light component having the wavelength λ₂ₘ input to the second end 116D of the optical fiber 110D, and outputs multiplexed light having wavelengths λ₁ to λ_{2M} from the second end 116C of the optical fiber 110C.

The optical waveguide type diffraction grating device included in each of the above multiplexing/demultiplexing modules 10, 20, and 30 is an optical waveguide type diffraction grating device 100 according to the present invention as described above which has a phase-inverted portion and exhibits high reflecting characteristics. Since the optical waveguide type diffraction grating device 100 has low transmittance in the reflection wavelength band and low reflectance out of the reflection wavelength band, any of the multiplexing/demultiplexing modules 10, 20 and 30 has a low possibility of cross talk, a low reception error rate, and a small power loss of light having the reflection wavelength λ₂ₘ even when the difference between the reflection wavelength λ₂ₘ and the transmission wavelength λ₂ₘ₋₁ is small.

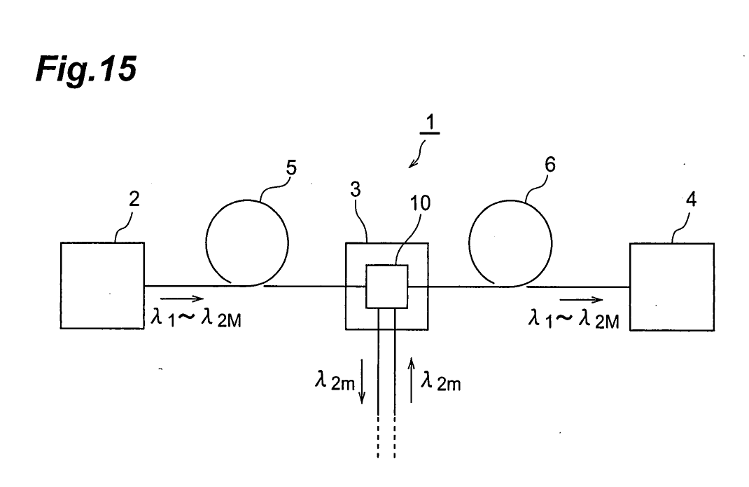

Next, an embodiment of an optical transmission system according to the present invention will now be described. FIG. 15 is a view showing a configuration of an optical transmission system 1 of one embodiment according to the present invention. The optical transmission system 1 comprises a transmitter station 2, a repeater station 3 connected to the transmitter station 2 through an optical fiber transmission path 5, a repeater station 3, a receiver station 4 connected to the a repeater station 3 through an optical fiber transmission path 6, and a multiplexing/demultiplexing module 10 provided at the repeater station 3.

The transmitter station 2 outputs multiplexed signal light components having wavelengths λ₁ to λ_{2M} into the optical transmission path 5. The multiplexed signal light components having the wavelengths λ₁ to λ_{2M}, which has propagated through the optical fiber transmission path 5, is inputted to the repeater station 3 and is demultiplexes at the multiplexing/demultiplexing module 10. Then, the signal light component having a wavelength λ₂ₘ₋₁ is sent into the optical fiber transmission path 6 and the signal light component having a wavelength λ_{2M} is sent into another optical fiber transmission path. The repeater station 3 also transmits signal light component having the wavelength λ₂ₘ inputted through another optical fiber transmission path to the optical fiber transmission path 6. The signal light components having the wavelengths λ₁ to λ_{2M}, which has propagated through the optical fiber transmission path 6, is inputted to the receiver station 4, which receives the signal light components by demultiplexing them into each wavelength.

In the optical transmission system 1, signal light components having wavelengths λ₁ to λ_{2M} are multiplexed or demultiplexed by using the multiplexing/demultiplexing module 10 including the optical waveguide type diffraction grating device 100 according to the above embodiment. Therefore, there is a low possibility of cross talk, a low reception error rate, and a small power loss of light having the reflection wavelength λ₂ₘ even when the difference between the reflection wavelength λ₂ₘ and the transmission wavelength λ₂ₘ₋₁ of the optical waveguide type diffraction grating device 100 is small. The multiplexing/demultiplexing module 20 or 30 may be provided instead of the multiplexing/demultiplexing module 10.

The invention is not limited to the above-described embodiments and may be modified in various ways. For example, the optical waveguide type diffraction grating devices in the above-described embodiments are obtained by forming a diffraction grating employing diffractive index modulation on an optical fiber that is an optical waveguide. However, the invention is not limited to them, and a diffraction grating based on refractive index modulation may be formed i-n an optical waveguide formed on a planar substrate.

As described in detail above, the invention makes it possible to manufacture an optical waveguide type diffraction grating device having desired optical characteristics easily.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of manufacturing an optical waveguide type diffraction grating device which comprises an optical waveguide, and a diffraction grating as refractive index modulation formed over a predetermined range of said optical waveguide in a longitudinal direction thereof, said method comprising the steps of:
arranging a phase grating mask beside said optical waveguide;
irradiating the optical waveguide as refractive index change inducing light through said phase grating mask while scanning the irradiating position of the refractive index change inducing light plural times in the longitudinal direction;
relatively displacing said phase grating mask longitudinally in the direction opposite to each other from a reference relative position of said phase grating mask relative to said optical waveguide, every scan among the plurality of scans; and
forming a diffraction grating based on refractive index modulation in said optical waveguide so as to manufacture said optical waveguide type diffraction grating device.

2. A method of manufacturing an optical waveguide type diffraction grating device according to claim 1, wherein said phase grating mask is displaced by a displacement corresponding to the irradiating position of the refractive index change inducing light during each of the plurality of scans.

3. A method of manufacturing an optical waveguide type diffraction grating device according to claim 1, wherein the phase grating mask is relatively displaced only in either direction from the reference relative position during each of the plurality of scans.

4. A method of manufacturing an optical waveguide type diffraction grating device according to claim 1, wherein the scanning of the irradiating position of the refractive index change inducing light is performed an even number of times,
wherein said phase grating mask is relatively displaced along a first direction from the reference relative position, in odd-numbered scans among the even number of scans; and
wherein said phase grating mask is relatively displaced along a second direction opposite to the first direction from the reference relative position, in even-numbered scans.

5. An apparatus of manufacturing an optical waveguide type diffraction grating device which comprises an optical waveguide, and a diffraction grating as refractive index modulation formed over a predetermined range of said optical waveguide in a longitudinal direction thereof, said apparatus comprising:
phase grating mask-displacing means which displaces a phase grating mask arranged beside said optical waveguide longitudinally relative to said optical waveguide;
refractive index change inducing light radiating means which irradiates said optical waveguide as refractive index change inducing light through the displaced phase grating mask while scanning the irradiating position of the refractive index change inducing light plural times in the longitudinal direction; and
displacement controlling means which controls said phase grating mask displacing means such that the phase grating mask is relatively displaced longitudinally in the direction opposite to each other from a reference relative position of the phase grating mask relative to the optical waveguide, every scan among the plurality of scans.

6. An apparatus for manufacturing an optical waveguide type diffraction grating device according to claim 5, wherein said displacement controlling means controls said phase grating mask displacing means such that the phase grating mask is displaced by a displacement corresponding to the irradiating position of the refractive index change inducing light during each of the plurality of scans.

7. An apparatus for manufacturing an optical waveguide type diffraction grating device according to claim 5, wherein said displacement controlling means controls said phase grating mask displacing means such that the phase grating mask is relatively displaced only on either direction from the reference relative position longitudinally during each of the plurality of scans.

8. An apparatus for manufacturing an optical waveguide type diffraction grating device according to claim 5, wherein said refractive index change inducing light radiating means scans the irradiating position of the refractive index change inducing light an even number of times; and
wherein said displacement controlling means controls said phase grating mask displacing means such that the phase grating mask is relatively displaced along a first direction from the reference relative position in odd-numbered scans among the even number of scans, and such that the phase grating mask is relatively displaced along a second direction opposite to the first direction from the reference relative position in even-numbered scans.

9. An apparatus for manufacturing an optical waveguide type diffraction grating device according to claim 5, wherein said phase grating mask displacing means relatively displaces the phase grating mask by using a piezoelectric element.

10. An optical waveguide type diffraction grating device manufactured by using the method according to claim 1, comprising:
an optical waveguide; and
a diffraction grating with a refractive index modulation formed over a predetermined range of said optical waveguide in a longitudinal direction thereof.

11. An optical waveguide type diffraction grating device, comprising:
an optical waveguide; and
a diffraction grating with a refractive index modulation formed over a predetermined range of said optical waveguide in a longitudinal direction thereof,
wherein the reflectance of a reflection peak in a band other than a Bragg reflection wavelength band based on a fundamental period of the refractive index modulation is −30 dB or less.

12. An optical waveguide type diffraction grating device according to claim 11, wherein the maximum reflectance of the Bragg reflection wavelength band is 90% or more.

13. A multiplexing/demultiplexing module, comprising an optical waveguide type diffraction grating device according to claim 10,
wherein said optical waveguide type diffraction grating device selectively reflects light having a reflection wavelength so as to multiplex or demultiplex the light.

14. An optical transmission system transmitting multiplexed light with multiple wavelengths, comprising a multiplexing/demultiplexing module according to claim 13,
wherein said multiplexing/demultiplexing module multiplexes or demultiplexes the multiplexed light with multiple wavelengths.
